(19) United States
(12) Patent Application Publication
(10) Pub. No.: US 2008/0007255 A1
(43) Pub. Date: Jan. 10, 2008

(54) Encoded linear position sensor

(75) Inventors: Stewart D. Johnson, Stockton, IL (US); EuGene D. Alfors, Rockford, IL (US); Lawrence E. Franzee, Freeport, IL (US); Joseph K. Murdock, Freeport, IL (US); Jason M. Chilcote, Frisco, TX (US); John S. Patin, Freeport, IL (US)

Correspondence Address: Bryan Anderson;Honeywell International Inc., 101 Columbia Rd., P.O. Box 2245, Morristown, NJ, 07962, US

(73) Assignee: Honeywell International Inc.

(21) Appl. No.: 11/483,481

(22) Filed: Jul. 10, 2006

(51) Int. Cl. G01B 7/14

(52) U.S. Cl. 324/207.24

(57) ABSTRACT

Multiple magnetic sensing transducers can detect the position of a target. For example, a linear array of transducers can detect a target's linear position. A master and slave arrangement can reduce the cost and size of a system containing multiple magnetic sensing transducers. The master contains circuitry for voltage regulation and processing logic as well as a magnetic sensing transducer. The slaves contain a magnetic sensing transducer and little else. As such, the slave units are small and inexpensive. The slaves obtain power from the master, produce detection signals, and pass the detection signals to the master. The master interprets the detection signals along with an internal detection produced by the master's internal magnetic sensing transducer to produce a position signal.

### TECHNICAL FIELD

Embodiments relate to sensors, Magnetic sensing transducers, and Hall transducers. Embodiments also relate to integrated circuits, bipolar electronics, and integrated circuit packaging.

### BACKGROUND OF THE INVENTION

Sensors are used to detect the presence or absence of environmental influences. Magnetic sensing transducers can detect the presence or absence of magnetic fields as well as changes in a magnetic field. The Hall transducer is a type of magnetic sensing transducer that is quite sensitive.

Magnetic sensing transducers are often used to detect the position of a target. A ferromagnetic target changes the nearby electric field. When it is moved close to a magnetic sensing transducer, the magnetic field change is detected. For example, a ferromagnetic target can be placed on a rotating shaft and a Hall transducer placed near the shaft. Each rotation of the shaft can be detected as a pulse in the sensed magnetic field.

Multiple magnetic sensing transducers can be use to sense changes in the magnetic field at multiple locations. Returning to the previous example, the rotating shaft can be ringed with Hall sensors such that the actual angular position of the shaft is detected.

The current art magnetic sensing transducers, however, are too expensive and bulky for some applications. In particular, position sensing applications requiring multiple magnetic sensing transducers are sensitive to size and expense. Systems and techniques for providing magnetic sensing transducers that are smaller and less expensive than those provided by current art are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments to use multiple magnetic sensing transducers such as Hall transducers. The magnetic sensing transducers are distributed amongst a master and one or more slaves. A master contains one of the magnetic sensing transducers as well as a voltage regulator and processing logic. The master is powered by a circuit voltage, often called Vcc. The master's voltage regulator uses Vcc to produce a regulated voltage called Vreg. Vreg is used to power the magnetic sensing transducer in the master. A slave contains a magnetic sensing transducer and is powered by Vreg. As such, Vreg is output by the master and input to the slave. As such, the slave does not need to include a voltage regulator.

It is also an aspect of the embodiments that the magnetic sensing transducers can sense a target if the target changes the ambient magnetic field or produces a magnetic field. A ferromagnetic material can both produce and change magnetic fields. A conductor moving through a magnetic field can develop eddy currents that produce a magnetic field. As such, a target can include ferromagnetic material, conductive material, or both.

It is another aspect of the embodiments that the magnetic sensing transducers produce signals. The master's magnetic sensing transducer produces an internal detection signal while the slave's magnetic sensing transducers produce detection signals. The detection signals are passed to the master where they are used as inputs to the processing logic. The processing logic produces a position signal based on the detection signals and the internal detection signal.

It is an aspect of certain embodiments to use one or more biasing magnets. Biasing magnets can be used to establish an ambient magnetic field. Hall transducers can be biased by the ambient magnetic field such that they are more sensitive. The ambient magnetic field produced by biasing magnets can also produce eddy currents in a moving target containing an electrically conductive material.

It is also an aspect of some embodiments that the target is patterned or contains a window. The magnetic sensing transducers can be arranged in a line to detect the linear position of the target. A solid target is detected most strongly by the closest magnetic sensing transducers. A windowed target is detected most strongly by magnetic sensing transducers close to the sides of the window. Similarly a patterned target has areas that are sensed strongly and areas that are not. Magnetic sensing transducers aligned with the strongly sensed areas produce detection signals that are different from those produced by magnetic sensing transducers by other areas. The processing logic can interpret the pattern of the detection signals to determine the position of the target.

It is a further aspect of some embodiments to mount the master and slaves within or on a housing. The housing creates a single unit that contains the magnetic sensing transducers and maintains the relative positions between them. A circuit board within the housing can provide electrical connectivity for the various voltages and signals. The housing can also provide a single electrical connection for supplying power and obtaining the position signal.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates a master and four slaves in accordance with aspects of the embodiments;

FIG. 2 illustrates a master and four slaves in a housing with a nearby target in accordance with aspects of the embodiments;

FIG. 3 illustrates a windowed target in accordance with aspects of the embodiments;

FIG. 4 illustrates a patterned target in accordance with aspects of the embodiments;

FIG. 5 illustrates a slave containing a Hall transducer in accordance with aspects of the embodiments;

FIG. 6 illustrates using biasing magnets in accordance with aspects of the embodiments;

FIG. 7 illustrates a high level flow diagram of sensing a targets position in accordance with aspects of the embodiments;

FIG. 8 illustrates a target for producing an encoded output pattern in accordance with aspects of the embodiments; and

FIG. 9 illustrates a sensor array for producing an encoded output pattern in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

Multiple magnetic sensing transducers can detect the position of a target. For example, a linear array of transducers can detect a target's linear position. A master and slave arrangement can reduce the cost and size of a system containing multiple magnetic sensing transducers. The master contains circuitry for voltage regulation and processing logic as well as a magnetic sensing transducer. The slaves contain a magnetic sensing transducer and little else. As such, the slave units are small and inexpensive. The slaves obtain power from the master, produce detection signals, and pass the detection signals to the master. The master interprets the detection signals along with an internal detection produced by the master's internal magnetic sensing transducer to produce a position signal.

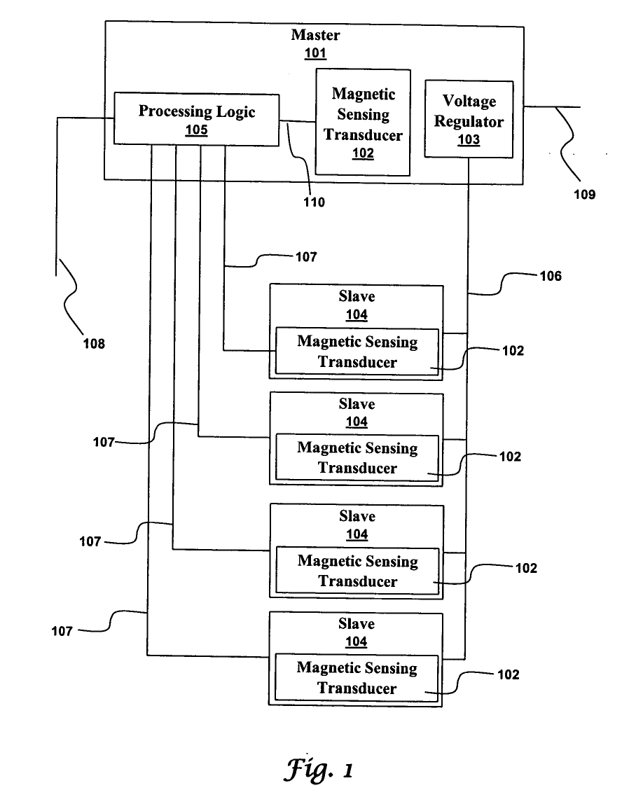

FIG. 1 illustrates a master 101 and four slaves 104 in accordance with aspects of the embodiments. The master contains a magnetic sensing transducer 102, a voltage regulator 103, and processing logic 105. The master 101 is powered by a circuit voltage, Vcc 109. The voltage regulator uses Vcc 109 to produce Vreg 106 that is a regulated voltage used to power the slaves 104.

Each slave contains a magnetic sensing transducer 102 and produces a detection signal 107 that is passed to the processing logic 105. An internal detection signal 110 is produced by the magnetic sensing transducer 102 in the master 101. The processing logic 105 uses the detection signals 107 and the internal detection signal 110 to produce a position signal 108.

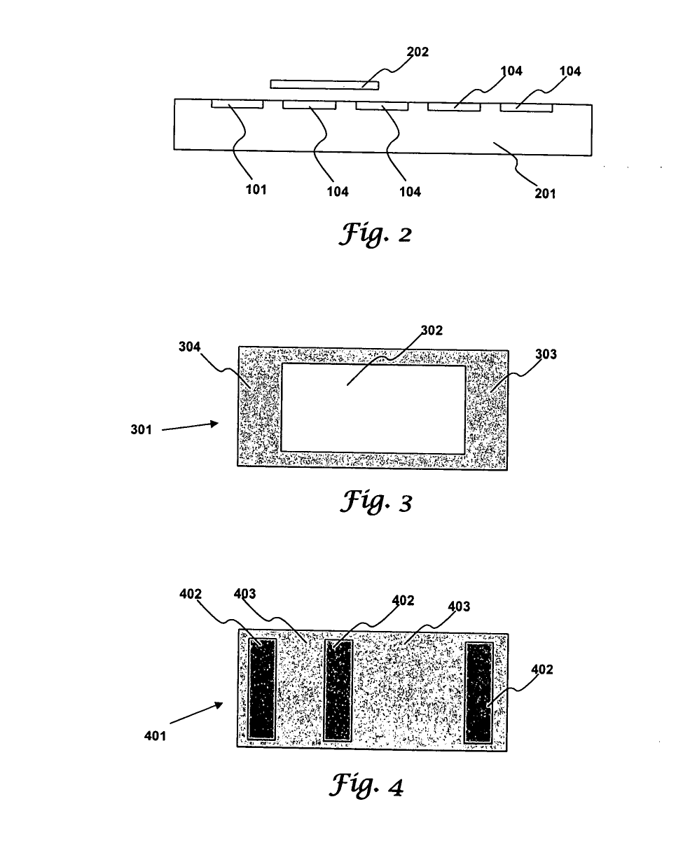

FIG. 2 illustrates a master 101 and four slaves 104 in a housing 201 with a nearby target 202 in accordance with aspects of the embodiments. The master 101 and the slaves 104 are mounted to the housing 201 in a line such that they form a linear sensing array. The target 202 can move back and forth along the linear sensing array. The master 101 produces a position signal indicating the target's 202 linear position along the linear sensing array.

FIG. 3 illustrates a windowed target 301 in accordance with aspects of the embodiments. The target 301 can include ferromagnetic material, conductive material, or both. The window 302 can be a hole cut in the target 301 or be a material that does not influence the magnetic field. The magnetic sensing transducers detect the left edge 304 and the right edge 303 of the target more strongly than the window 302 area. The processing logic can use the detected positions of the right edge 303 and left edge 304 to infer the target position.

FIG. 4 illustrates a patterned target 401 in accordance with aspects of the embodiments. The target has a strongly sensed areas 402 and weakly sensed areas 403. The magnetic sensing transducers detect the strongly sensed areas 402 more strongly than the weakly sensed areas 403. The processing logic can use the detected positions of the strongly sensed areas 402 strongly sensed areas 403 to infer the target position. The strongly sensed areas can include a ferromagnetic material, a conductive material, or both. The weakly sensed areas can include a conductive material if there is a weak ambient magnetic field or when target movements will not result in problematic induced magnetic fields from eddy currents in the conductor. The weakly sensed areas can be made of any material that is not strongly sensed.

The target 401 is illustrated as a weekly sensed base material with a strongly sensed areas patterned on or into it. An equivalent patterned target has a strongly sensed base material with weakly sensed areas patterned on or into it. For example, a ferromagnetic sheet with multiple windows punched into it is a patterned target. The windowed target 301 of FIG. 3 is a type of patterned target.

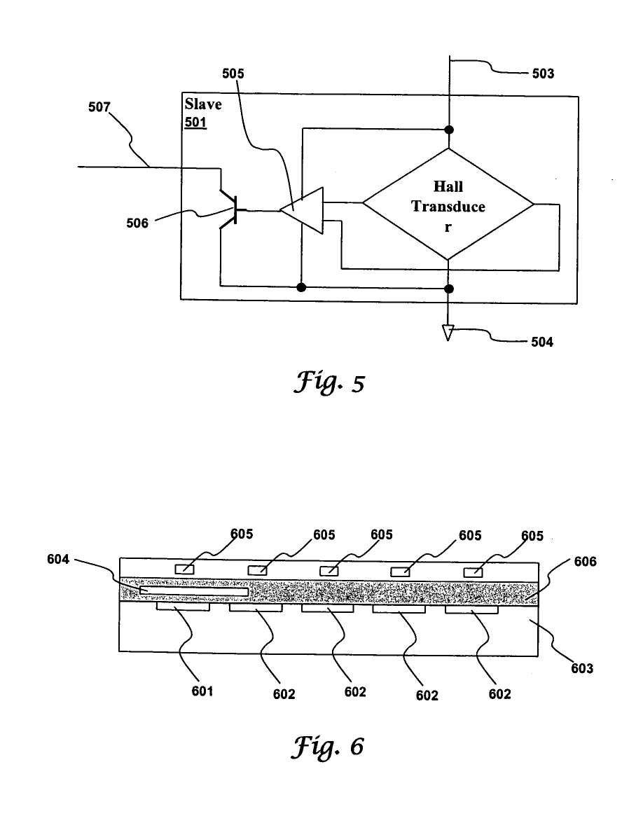

FIG. 5 illustrates a slave 501 containing a Hall transducer 502 in accordance with aspects of the embodiments. Vreg 503 powers the slave 501 with a ground node 504 sinking current. The Hall transducer output is passed to a conditioner 505. The conditioner 505 can be an op amp, comparator, differential amp, or similar circuit as is commonly used in buffering or conditioning weak signals. The conditioner 505 drives a transistor 506, with a bipolar transistor illustrated. The transistor output 507 carries the detection signal. The combination of magnetic sensing transducer 502, conditioner 505, and transistor 506 is a type of magnetic sensing module. Other magnetic sensing modules contain only a magnetic sensing transducer. All magnetic sensing modules contain a magnetic sensing transducer and produce a detection signal.

FIG. 6 illustrates using biasing magnets 605 in accordance with aspects of the embodiments. A master 601 and four slaves 602 are mounted to a housing 603 in a line such that they form a linear sensing array. The target 202 can move back and forth along the linear sensing array. The master 101 produces a position signal indicating the target's 202 linear position along the linear sensing array. The housing 603 has a slot 606 in which a target 604 moves in a linear fashion. Bias magnets 605 are mounted in the housing across the slot 606 from the sensors 601,602. The bias magnets create an ambient magnetic field which can bias Hall transducers and induce eddy currents within a conductive target. As discussed above, currents, such as the eddy currents, produce a magnetic field.

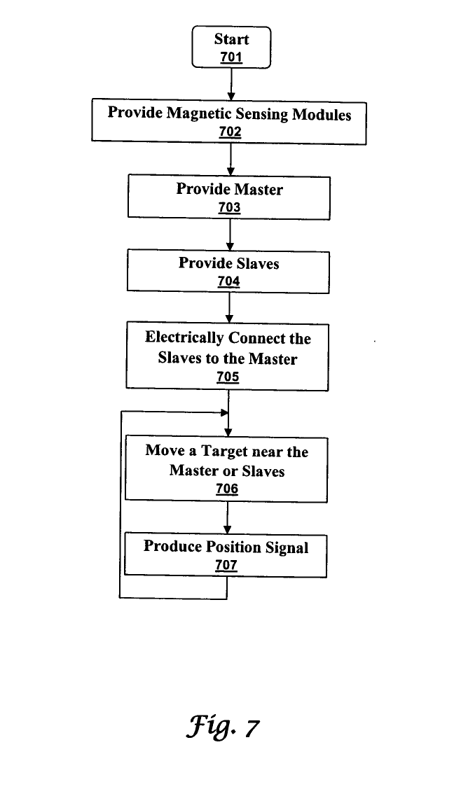

FIG. 7 illustrates a high level flow diagram of sensing a targets position in accordance with aspects of the embodiments. After the start 701, magnetic sensing modules are provided. A master is provided 703 and some slaves are provided 704. In some embodiments, the master and the slaves are manufactured in a manner that also produces magnetic sensing modules. In such embodiments, block 702 is implicitly contained within blocks 703 and 704.

The master and the slaves are wired 705 into a circuit such that a sensor array is formed and detection signals and a position signal are available. A target is moved near the sensor array 706 and a position signal is produced 707 indicating the target position. The process then iterates with the target moving, or staying still, and its position being sensed.

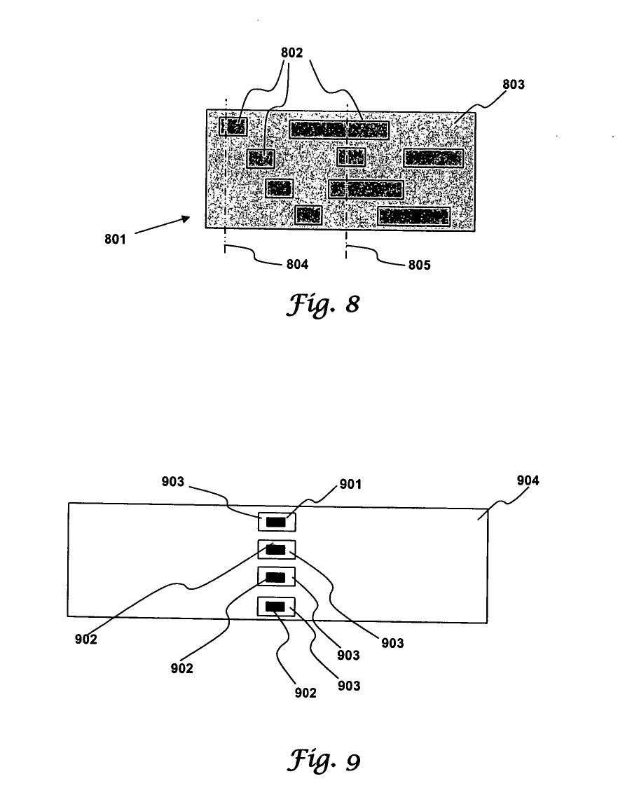

FIG. 8 illustrates a target 801 for producing an encoded output pattern in accordance with aspects of the embodiments. The target 801 has weakly sensed base material 803 and a pattern of strongly sensed areas 802. The strongly sensed areas 802 are arranged such that an array of four vertically arranged magnetic sensing modules can sense different target 801 positions as the target 801 moves from left to right.

FIG. 9 illustrates a sensor array for producing an encoded output pattern in accordance with aspects of the embodiments. A master 901 and three slaves 902 comprise magnetic sensing modules and are vertically arranged with biasing magnets 903. A housing 904 holds the master 901, slaves 902, and magnets 903 in place. A target, and in particular the target 891 of FIG. 8, can be aligned with the housing and moved to the left and right. One or more magnetic sensing module can detect a strongly sensed area. The four magnetic sensing modules produce four detection signals. The detection signal pattern indicates the target position. For example, only the master's detection signal indicates a strongly sensed area when the target 801 is in a far right position 804. The target is in a nearly centered position 805, however, when the master 901 and top two slaves indicate strongly sensed areas while the lower slave does not.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
at least two magnetic sensing transducers that can sense a target;
a master comprising a voltage regulator, processing logic, and one of the at least two magnetic sensing transducers;
at least one slave wherein each one of the at least one slave comprises one of the at least two magnetic sensing transducers and wherein each one of the at least one slave is powered by the voltage regulator;
at least one detection signal produced by the at least one slave;
an internal detection signal produced inside the master; and
a position signal produced by the processing logic based on the at least one detection signal and on the internal detection signal.

2. The system of claim 1 further comprising a housing onto which the master and the at least one slave are mounted.

3. The system of claim 1 further comprising a window in the target.

4. The system of claim 1 wherein the target is patterned.

5. A system comprising:
at least two hall transducers that can sense a target;
a master comprising a voltage regulator, processing logic, and one of the at least two hall transducers;
at least one slave wherein each one of the at least one slave comprises one of the at least two hall transducers and wherein each one of the at least one slave is powered by the voltage regulator;
at least one detection signal produced by the at least one slave;
an internal detection signal produced inside the master; and
a position signal produced by the processing logic based on the at least one detection signal and on the internal detection signal.

6. The system of claim 5 further comprising at least one bias magnet positioned to bias the at least two hall transducers.

7. The system of claim 6 wherein the target comprises a conductive material.

8. The system of claim 7 further comprising a window in the target.

9. The system of claim 8 further comprising a housing onto which the master and the at least one slave are mounted.

10. The system of claim 5 wherein the target comprises a ferromagnetic material.

11. The system of claim 10 further comprising a window in the target.

12. The system of claim 10 further comprising a housing onto which the master and the at least one slave are mounted.

13. The system of claim 5 further comprising a housing onto which the master and the at least one slave are mounted.

14. The system of claim 6 wherein the target comprises a conductive material and wherein the target is patterned.

15. The system of claim 5 wherein the target comprises a ferromagnetic material and wherein the target is patterned.

16. A method comprising:
providing at least two magnetic sensing modules that can sense a target wherein the at least two magnetic sensing modules produce at least two detection signals;
providing a master comprising signal conditioning circuitry, processing logic, and one of the at least two magnetic sensing modules;
providing at least one slave wherein each one of the at least one slave comprises one of the at least two magnetic sensing modules powering each one of the at least one slave from the master;
positioning the target in proximity to at least one of the at least two magnetic sensing modules; and
producing a position signal based on the at least two detection signal to indicate the position of the target.

17. The method of claim 16 further comprising providing at least two hall transducers wherein each one of the at least two magnetic sensing modules comprises one of the at least two hall transducers.

18. The method of 17 further comprising using at least one magnet to bias the at least two hall transducers.

19. The method of claim 17 wherein the target comprises a conductive material.

20. The method of claim 16 wherein the target comprises a ferromagnetic material.
